(19) United States
(12) Patent Application Publication
(10) Pub. No.: US 2025/0075710 A1
(43) Pub. Date: Mar. 6, 2025

(54) BOREHOLE SYSTEM HAVING CONVERTER MODULE FOR SAFETY VALVE, CONVERTER MODULE, AND METHOD

(71) Applicant: Baker Hughes Oilfield Operations LLC, Houston, TX (US)

(72) Inventors: Jason Edwards, Tulsa, OK (US); John Burris, Bixby, OK (US)

(21) Appl. No.: 18/458,581

(22) Filed: Aug. 30, 2023

(51) Int. Cl. F15B 3/00; E21B 34/16

(52) U.S. Cl. CPC F15B 3/00; E21B 34/16

(57) ABSTRACT

A borehole system having a string, the string including a converter module fluidically connectable to a downhole tool, the converter module including a piston in fluidic communication with the downhole tool, wherein the converter module is configured to provide a source of converter module pressure to the downhole tool. A method of connecting the downhole tool to a source of balance pressure includes fluidically connecting a balance line chamber of the converter module to a balance line of the downhole tool, the converter module having a piston, the piston fluidically engageable with the balance line chamber, wherein the piston is movable in response to changes in balance line fluid pressure within the balance line chamber.

### BACKGROUND

In the resource recovery industry and fluid sequestration industry, subsurface safety valves are used in wells to close off the well in the event of an uncontrolled condition. Typically, these valves include a flapper, which is the closure element and is pivotally mounted to rotate 90 degrees between an open and a closed position. For an open position, a hollow tube called a flow tube is actuated downwardly against the flapper to rotate the flapper to a position behind the tube and off its seat. When the flow tube is retracted, the flapper is urged by a spring to rotate to the closed position against the seat.

The flow tube is operated by a hydraulic control system that includes a control line from the surface to one side of a piston. Increasing pressure in the control line moves the piston in one direction and shifts the flow tube with it. This movement occurs against a closure spring that is generally sized to offset the hydrostatic pressure in the control line, friction losses on the piston seals and the weight of the components to be moved in an opposite direction to shift the flow tube up and away from the flapper so that the flapper can swing shut.

Normally, it is desirable to have the flapper go to a closed position in the event of failure modes in the hydraulic control system and during normal operation on loss of removal of control line pressure. The need to meet normal and failure mode requirements in a tubing pressure insensitive control system, particularly in a deep set safety valve application, is met by a downhole hydraulic control system with failsafe features, or balance line type safety valve, including a balance line to substantially reduce the effect of control line hydrostatic pressure such that the balance line enables such a valve to operate at pressures below tubing pressures.

The art would be receptive to systems and methods of utilizing features of a balance line type downhole tool in situations where the use of a balance line type downhole tool is precluded, such as in a well with a limited number of tubing hanger penetrations.

### SUMMARY

An embodiment of a borehole system having a string, the string including a converter module fluidically connectable to a downhole tool, the converter module including a piston in fluidic communication with the downhole tool, wherein the converter module is configured to provide a source of converter module pressure to the downhole tool.

An embodiment of a method of connecting a downhole tool to a source of balance pressure, the method including fluidically connecting a balance line chamber of a converter module to a balance line of the downhole tool, the converter module having a piston, the piston fluidically engageable with the balance line chamber, wherein the piston is movable in response to changes in balance line fluid pressure within the balance line chamber.

An embodiment of a converter module configured to connect a downhole tool to a source of balance pressure, the converter module including a housing having a first port and a second port, and further having a first chamber, a second chamber, and a third chamber, a piston disposed within the housing, the piston having a first end and a second end, the first chamber adjacent the first end of the piston, and the second chamber adjacent the second end of the piston, a first dynamic seal capable of sealing the piston within at least a portion of the housing and a second dynamic seal capable of sealing the piston within at least a portion of the housing, the third chamber disposed between the first and second dynamic seals, wherein the first port is fluidically accessible to the third chamber and is fluidically connectable to a source of pressure, and the second port is fluidically accessible to the second chamber and is fluidically connectable to the downhole tool.

An embodiment of a method of changing a source of balance line pressure in a balance line type downhole tool, the method including fluidically connecting the second chamber of the converter module to a balance line of the downhole tool.

### BRIEF DESCRIPTION OF THE DRAWINGS

The following descriptions should not be considered limiting in any way. With reference to the accompanying drawings, like elements are numbered alike:

FIG. 1 is a schematic view of an embodiment of a borehole system including a converter module and a downhole tool;

FIGS. 2A and 2B are schematic views of a safety valve in closed and open conditions, respectively, in relation to a converter module;

FIG. 3 is a schematic view of one embodiment of a converter module in relation to a downhole tool;

FIG. 4 is a schematic view of another embodiment of a converter module in relation to a downhole tool;

FIG. 5 is a schematic view of another embodiment of a converter module in relation to a downhole tool; and

FIG. 6 is a schematic view of another embodiment of a converter module in relation to a downhole tool.

### DETAILED DESCRIPTION

A detailed description of one or more embodiments of the disclosed apparatus and method are presented herein by way of exemplification and not limitation with reference to the Figures.

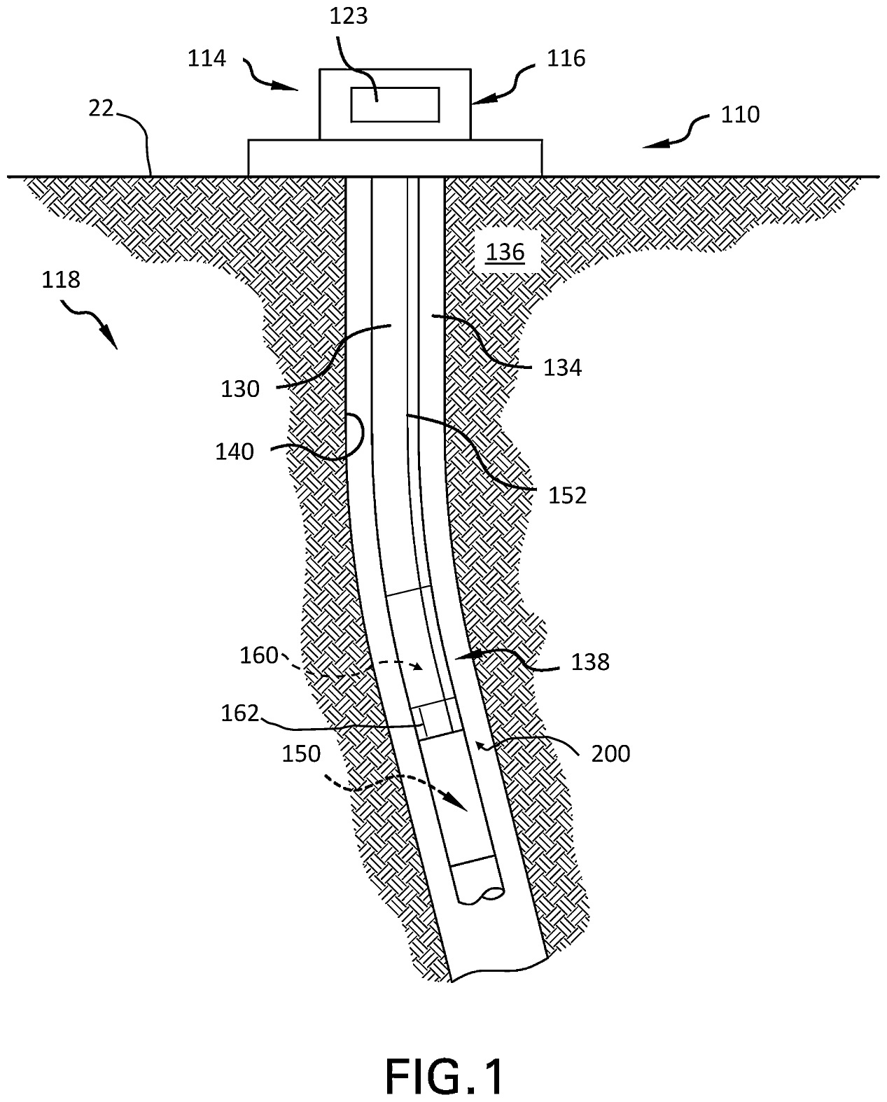

Referring to FIG. 1, a borehole system, such as a resource exploration and recovery system, in accordance with an exemplary embodiment, is indicated generally at 110. Borehole system 110 should be understood to include well drilling operations, completions, resource extraction and recovery. CO₂ sequestration, and the like. The borehole system 110 includes a borehole 134 in a subsurface formation 136. A string 130 is disposed within the borehole 134. A downhole tool 150, such as, but not limited to, a safety valve, barrier valve, ICV, and packer, and converter module 160 are disposed within or as a part of the string 130 disclosed herein. The downhole tool 150 in combination with the converter module 160 form a converted tool 200 as will be further described below.

Borehole system 110 may further include a first system 114 which, in some environments, takes the form of a surface system 116 at surface 22 (at or above ground or water) operatively and fluidically connected to a second system 118 which, in some environments, takes the form of a subsurface (under ground or under water) or downhole system.

First system 114 may include a control system 123 that may provide power to, monitor, communicate with, and/or activate one or more downhole operations as will be disclosed herein. Surface system 116 may include additional systems such as pumps, fluid storage systems, cranes and the like (not shown). Second system 118 includes the tubular string 130 that extends into the borehole 134 formed in the formation 136. Tubular string 130 of completion 138 includes a plurality of interconnected tubulars. Borehole 134 includes an annular wall 140 which may be defined by a surface of formation 136. Borehole 134 may include a casing tubular.

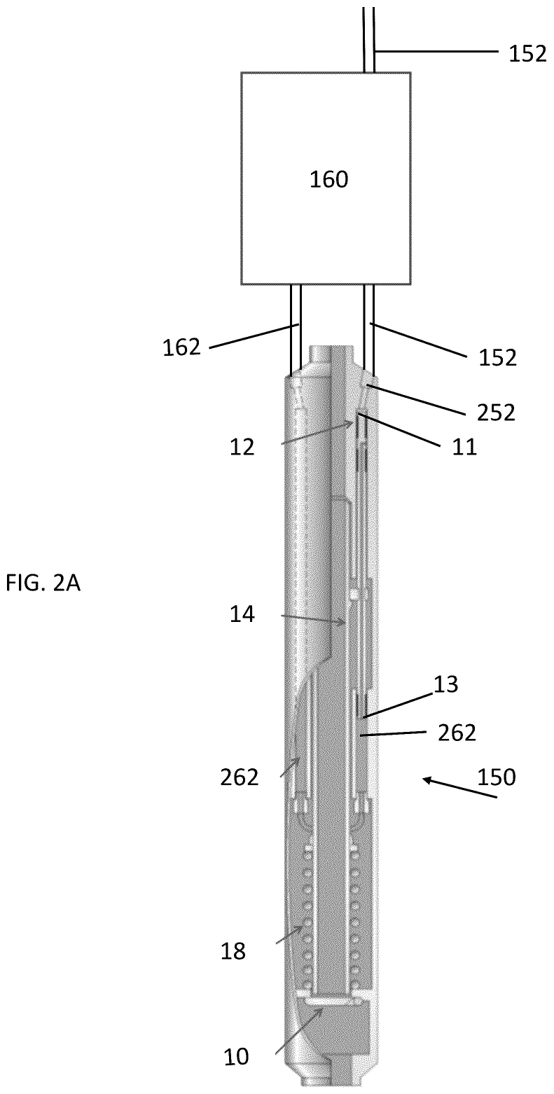

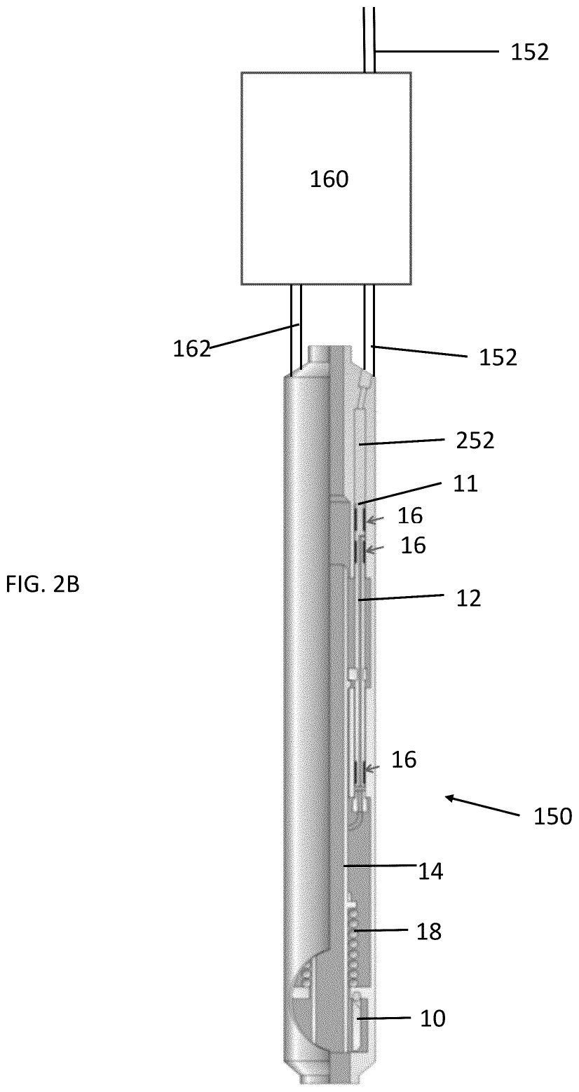

Tubular string 130 includes a downhole tool 150 (shown in FIGS. 2A and 2B as a subsurface safety valve in the form of a balance line type safety valve) that is operatively connected to first system 114 through a control line 152. Fluid pressure, such as hydraulic pressure, controlled by control system 123 is introducible into control line 152 to hydraulically control the downhole tool 150. The tubular string 130 further includes a downhole tool shown as converter module 160 that is, in the illustrated embodiment, mounted above (uphole of, closer to surface 22) the downhole tool 150 and as an integral part of the tubular string 130. The control line 152 may enter the top (uphole end) of the module 160 and exit the bottom (downhole end) of the module 160 to connect to the downhole tool 150, as in the illustrated embodiment. Alternatively, the control line 152 may extend adjacent the module 160 and may access the module 160 at a point along the control line 152. A balance line 162 exits from a chamber in the module 160 to connect to the top (uphole end) of the downhole tool 150. In an embodiment where the downhole tool 150 is a balance line type safety valve, typically the use of balance line type safety valves would include extending the balance line 162 to systems at surface 22. However, in wells that have a limited number of tubing hanger penetrations, or where the use of balance line type safety valves may be otherwise precluded or disadvantageous, or where inventory management is to be improved by only having one type of safety valve in stock, the module 160 enables the balance line type safety valve (represented at downhole tool 150) to be converted to a converted tool or converted valve 200, such as an atmospheric type safety valve or nitrogen charged valve, without making significant changes to the downhole tool 150 and while still maintaining the correct functionality of the downhole tool 150. Thus, the converter module 160 is capable of providing converter module pressure to the downhole tool 150, distinct from the hydraulic control pressure provided to the downhole tool 150 via control line 152. The converter module pressure may be balance pressure, and may come from alternate sources than what the downhole tool 150 was originally intended to receive. As will be further described below, the downhole tool 150 may include a downhole tool piston where the hydraulic control pressure acts upon a first end of the piston and the converter module pressure (such as, but not limited to balance pressure) acts upon a second end of the piston. As will additionally be further described below, the converter module 160 includes a converter module piston utilized in applying the converter module pressure to the downhole tool 150.

The converter module 160 may be utilized with a variety of downhole tools 150, but one embodiment of such a downhole tool 150 is shown in FIGS. 2A and 2B as a tubing pressure insensitive safety valve. When control pressure is applied to the downhole tool 150 via the control line 152, the downhole tool 150 operates to move a flapper 10 between closed condition shown in FIG. 2A to the open condition shown in FIG. 2B, with a fail-safe condition being the closed condition shown in FIG. 2A. To open the flapper 10, pressure is applied through the control line 152 to act on a downhole tool piston(s) 12 (such as on an uphole or first end 11 of piston 12), the piston 12 having dynamic seals 16 (FIG. 2B), the pressure forcing the piston 12 down against an opposing force of closure spring 18. The spring 18 is biased to push a flow tube 14 upwards (in an uphole direction towards surface 22) and thus provides stored potential energy (when compressed) to assist in closing the downhole tool 150 when hydraulic pressure is removed or lost within the control line 152. When the pressure is applied through the control line 152, the piston 12 engages with the flow tube 14 to compress spring 18, against the opposing force of the spring 18. Movement of the flow tube 14 in a downhole direction engages an end of the flow tube 14 with the flapper 10, thus pivoting the flapper 10 to the side of the downhole tool 150 and opening a flowbore of the downhole tool 150 for flow therethrough along its longitudinal axis, as shown in FIG. 2B.

The downhole tool 150 depicted in FIGS. 2A and 2B is a balance line type safety valve or tubing pressure insensitive type safety valve because it includes a balance line 162 having balance line fluid 262 that, in absence of the converter module 160 and with connection of the balance line 162 to surface 22, provides a balanced hydrostatic pressure to the piston 12 (such as at a downhole or second end 13 of piston 12) so that the spring 18 does not have to overcome the hydrostatic pressure of the control line fluid 252 in the control line 152 in order to actuate the safety valve to the closed condition shown in FIG. 2A. In embodiments of balance line type safety valves, the spring 18 does not need to be sized to overcome hydrostatic pressure of the control line fluid 252 because the balance line 162 provides a balanced hydrostatic pressure. That is, in the prior art, a balance line of a balance line type safety valve would be connected to surface 22 rendering the safety valve insensitive to tubing pressure such that the spring 18 would not have to overcome the hydrostatic pressure of the control line fluid 252.

In the embodiments described herein, in lieu of connecting the balance line 162 to surface 22, the converted tool 200 utilizes the converter module 160 within the string 130 to fluidically connect to the balance line 162 and fluidically connect to the balance fluid 262 in the downhole tool 150. By removing the balance line to surface feature from the downhole tool 150, the downhole tool 150 is now sensitive to the pressure output of the converter module. Since the spring 18 in the balance line type safety valve or downhole tool 150 was selected such that it would not have to overcome hydrostatic pressure in the control line 152, the converter module 160 is configured to contain an additional source of pressure and/or potential energy that can be used to provide pressure such as for closing assistance to the safety valve or downhole tool 150. Thus, the converted valve 200 has the benefit of the smaller spring 18 within the safety valve or downhole tool 150 while not requiring a balance line-to-surface connection. While a balance line type safety valve converted to a single line safety valve with converter module has been particularly described, the converter module 160 may also be employed with other downhole tools 150 for providing such downhole tools 150 with an alternate source of pressure.

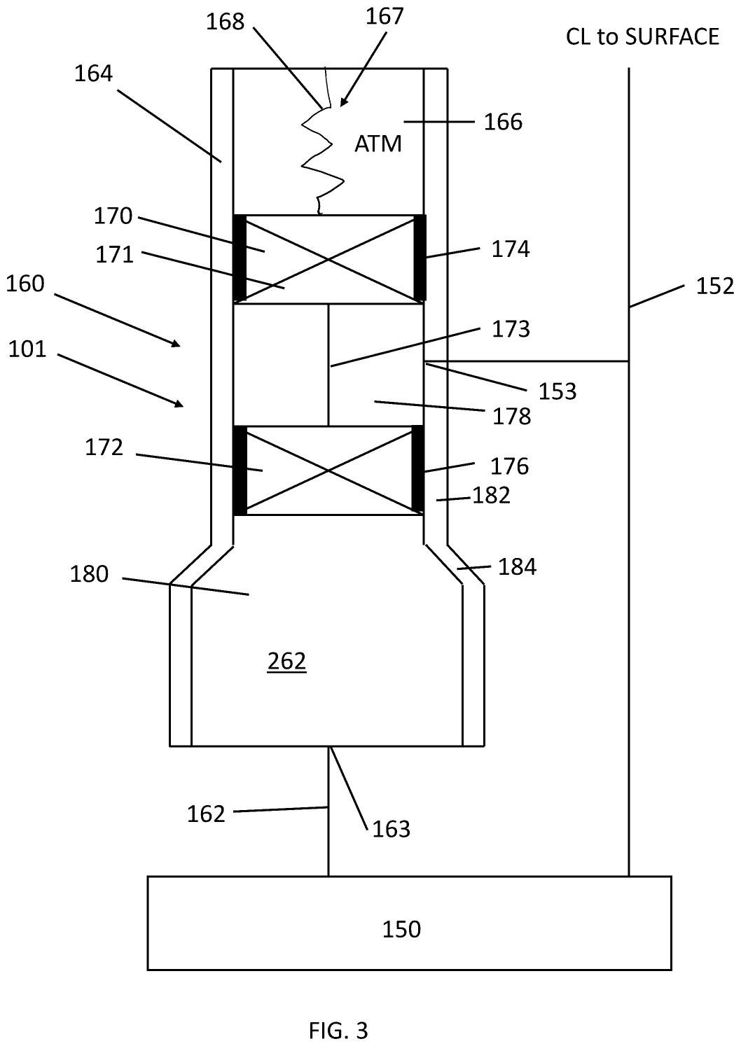

Turning now to FIG. 3, one embodiment of the converter module 160 (alternatively termed an “accumulator module”) is diagrammatically depicted as converter module 101. The illustrated embodiment of module 160 includes a housing 164 containing a first chamber 166, which may be an atmospheric (ATM) chamber or any lower pressure zone having any pressure lower than the hydrostatic pressure of the control line, a stored energy device 167 in the form of a spring 168, and one or more converter module pistons 170, with first and second dynamic seals 174, 176. The piston 170 may include seal-carrying portions 171, 172 and a connecting rod portion 173. The chamber 166 is located uphole of the first (upper) dynamic seal 174 of piston 170, and the chamber 166 contains the spring 168. The spring 168 is sized to output a specific pressure based on the downhole tool's application.

Between the first (upper) dynamic seal 174 and the second (lower) dynamic seal 176, pressure from the operating control line 152 is applied to a third chamber or seal chamber 178 via a first port or control line port 153 in the housing 164. Since the first (upper) and second (lower) dynamic seals 174, 176 are of at least substantially equal size, the force from the control line 152 exerts no net force on the piston 170. Below the second (lower) dynamic seal 176 is a second chamber or hydraulic chamber or balance line chamber 180, which is a hydraulic fluid-filled chamber having a second port or balance line port 163 fluidically connectable to balance line 162 of the downhole tool 150. The housing 164 includes a first section 182 providing an inner bore where the dynamic seal 176 is engageable with the inner wall of the first section 182. The housing 164 further includes a second section 184 having an inner bore that has a greater inner diameter than an inner diameter of the first section 182. Thus, the dynamic seal 176 is not engageable with the inner bore of second section 184 when the piston 170 is moved and positions the dynamic seal 176 within the second section 184.

On surface, the pressure in the hydraulic balance line chamber 180 below the second (lower) seal 176 is charged to the hydrostatic fluid pressure expected at the setting depth of downhole tool 150. The downhole tool 150 plus converter module 160 (together forming converted tool 200) are run in hole. When pressure is applied to the operating control line 152, fluid 262 from balance line 162 is pushed out through the balance line 162 by the piston 12 (see FIGS. 2A and 2B). Since the balance line 162 is connected to the port 163 of the module 160, the fluid 262 enters the chamber 180 and pushes up on the piston 170 and acts on second (lower) seal 176, which is only opposed by the force of the power spring 168. As the well is brought online, the fluid in the balance line 162 and hydraulic balance line chamber 180 will expand, which will cause the power spring 168 to compress further to compensate for fluid expansion. If the distance between the module 160 and the downhole tool 150 is kept relatively short (such as by placing the module 160 directly above or substantially adjacent to the downhole tool 150), then the amount of compensation required for thermal expansion will be very small, causing negligible changes in operating pressure of the downhole tool 150. With reference again to FIGS. 2A and 2B, when the downhole tool 150 is a safety valve, in the event the hydraulic pressure is removed from control line 152, the closure spring 18 will bias the flow tube 14 in an uphole direction. The reduction of pressure in the second chamber 180 of the module 160 will allow the spring 168 to decompress and further push the fluid 262 towards the second end 13 of piston 12, thus compensating for any insufficiencies the spring 18 might have in overcoming hydrostatic pressure of the control line fluid 252 to move the flow tube 14.

The converter module 160 further includes a replenishment feature that enables it to be reset in the event that balance line fluid 262 is lost. If fluid in the balance line 162/hydraulic balance line chamber 180 below the second (lower) dynamic seal 176 is lost, this will cause a drop in pressure in the chamber 180. The power spring 168 will expand to compensate. If the pressure drops too much, the second (lower) dynamic seal 176 will exit the first section 182 and enter the second section 184 where the larger bore of the second section 184 prevents the second seal 176 from being able to seal against the housing 164. This will allow fluid from the chamber 178 and operating control line 152 to enter the balance line 162. Once fluid levels have equalized, the pressure from the control line 152 will act on the first (upper) dynamic seal 174 to cause the piston 170 to shift up (compressing the power spring 168) and causing the second (lower) dynamic seal 176 to re-enter the inner bore of the first section 182, re-sealing against the housing 164 and sealing the chamber 178 from the chamber 180. This enables the module 160 to regain functionality in the event that balance line fluid 262 is lost due to seal leakage. Further, the only new leak paths introduced by this module 160 are from control line 152 to chamber 166 and from annulus to chamber 166. When the downhole tool 150 is a safety valve, either of these leaks will increase the closing pressure of the downhole tool 150, leading to a fail-closed condition.

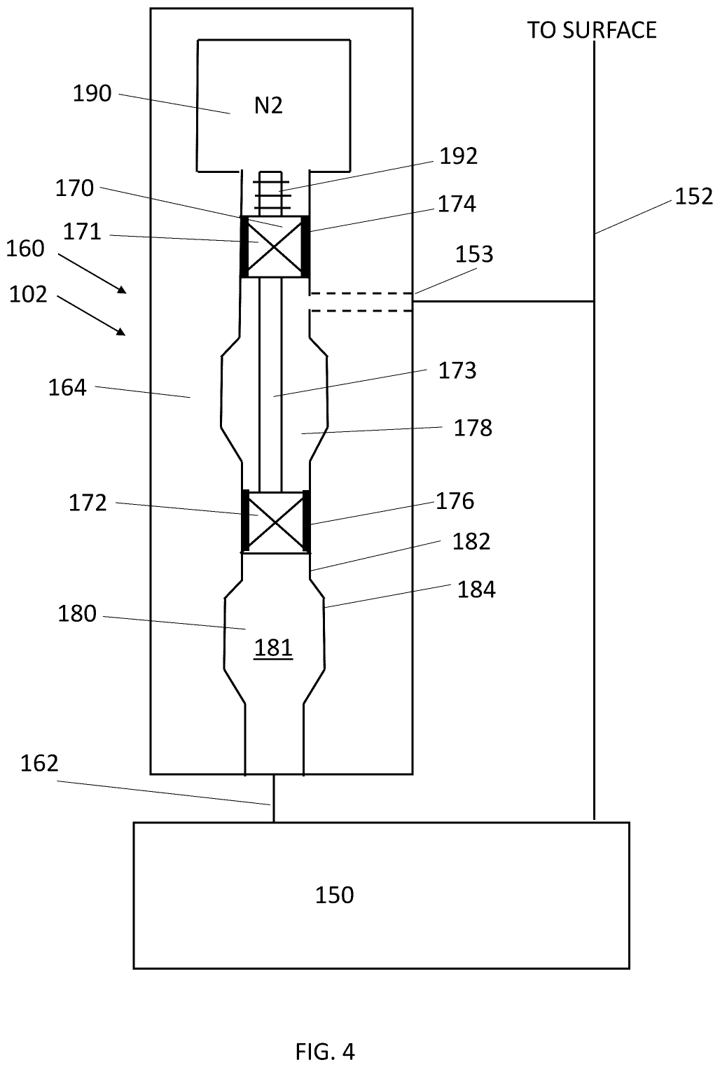

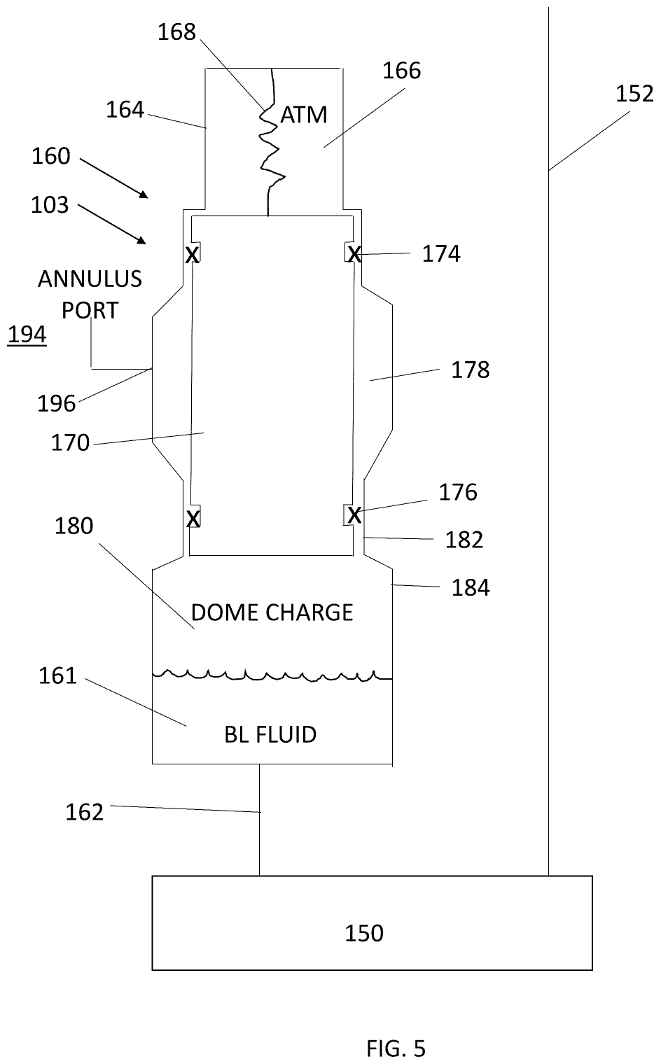

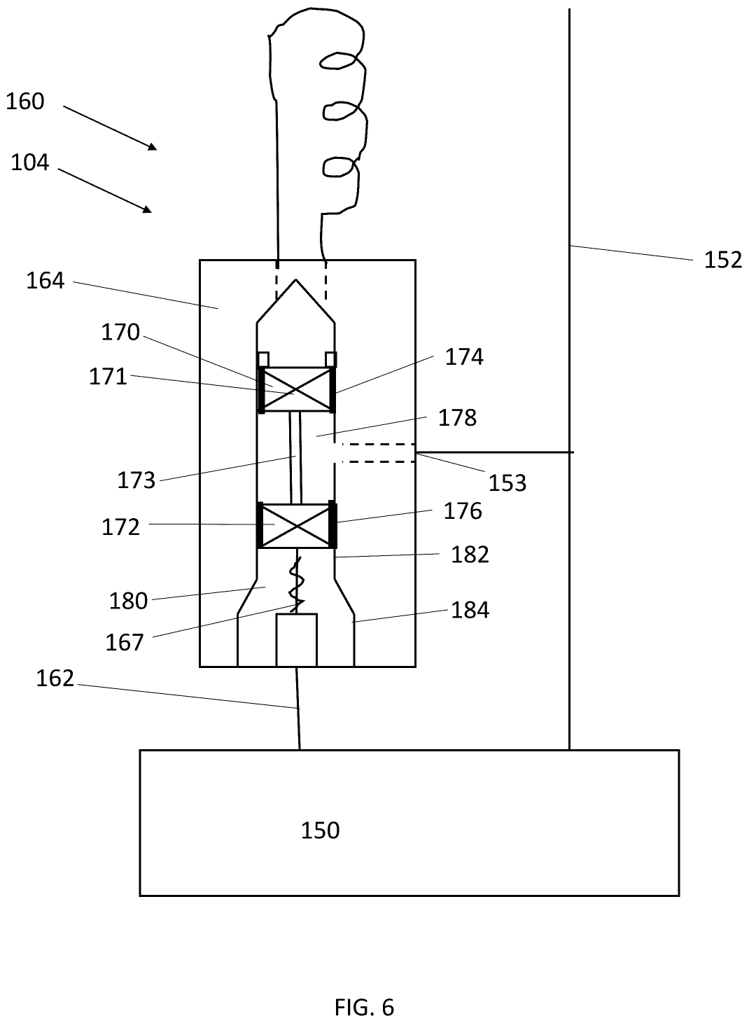

FIGS. 4-6 depict alternate embodiments of the converter module 160, where like numbers point to at least substantially like elements. In FIG. 4, converter module 102 employs a nitrogen charge in nitrogen chamber 190 instead of the atmospheric or otherwise lower pressure chamber 166 and power spring 168 of converter module 101 depicted in FIG. 3. The converter module 102 may further utilize a ratchet system 192 connected to piston 170. In FIG. 5, converter module 103 is open to annulus pressure in annulus 194 at the chamber 178 at annulus port 196 instead of fluidically connecting to the connecting line 152. FIG. 6 depicts another embodiment of converter module 160 where converter module 104 includes a stored energy device 167 within the chamber 180 that acts against the lower end of piston 170 in lieu of spring 168 or other stored energy device 167 acting against an upper end of the piston 170 as depicted in previous embodiments. A tension or extension spring could be employed within second chamber 180 instead of the compressible spring within the first chamber 166. Further, the converter module 104 may include a battery or other powered source or electrical connection to work in conjunction with stored energy device 167 and/or piston 170. In other alternative embodiments, chamber 166 may be open to annulus 194, and in such an embodiment may further not include power spring 168. While power spring 168 is diagrammatically depicted as a coil spring, other types of springs and stored energy devices 167 may alternatively be employed such as, but not limited to, wave springs and Belville washers.

A downhole tool 150, such as a tubing pressure insensitive balance line type safety valve requiring two control lines, is thus able to be converted to tubing pressure insensitive safety valve requiring only one control one in cases where tubing hanger penetrations are limited or if otherwise desired. The converter module 160 enables a balance line type safety valve to be stock-converted to an alternate type of safety valve on demand. This further simplifies inventory management as only one valve need be kept in stock. The module 160 can be purchased after the valve has been manufactured and “bolted on” immediately before run in hole to allow a balance line type safety valve to be converted the module based safety valve without requiring the valve to be shipped back to a manufacturing facility and without requiring substantial modifications to the valve. Similarly, the converter module 160 can be fluidically communicable with balance fluid in other types of downhole tools 150 to provide the downhole tools with an alternate source of pressure. For example, the converter module 160 can be used to convert any valve that has a chamber below the piston into another type of valve by utilizing the converter module 160 to replace the chamber below the piston, such as replacing a nitrogen chamber with an atmospheric chamber or replacing an atmospheric chamber with a nitrogen chamber. Also, while the converter module 160 has been particularly described as replacing the force supplied by the balance line hydrostatic, another embodiment includes utilizing the converter module 160 to reduce the pressure on the piston below hydrostatic pressure. And while safety valves have been described herein, the converter module 160 can also be adapted to other types of valves, packers, and downhole devices.

Set forth below are some embodiments of the foregoing disclosure:

Embodiment 1: A borehole system having a string, the string including a converter module fluidically connectable to a downhole tool, the converter module including a piston in fluidic communication with the downhole tool, wherein the converter module is configured to provide a source of converter module pressure to the downhole tool.

Embodiment 2: The borehole system as in any prior embodiment, wherein the downhole tool is configured to receive hydraulic control pressure from a surface location by a hydraulic control line, and the converter module is configured to replace hydrostatic pressure from the hydraulic control line.

Embodiment 3: The borehole system as in any prior embodiment, wherein the converter module includes a stored energy source on one end of the piston and a balance line chamber in fluidic communication with the opposite end of the piston, the stored energy source configured to push the piston further into the balance line chamber upon a decrease of pressure within the balance line chamber.

Embodiment 4: The borehole system as in any prior embodiment, wherein the stored energy source includes at least one of a spring and a nitrogen charge.

Embodiment 5: The borehole system as in any prior embodiment, wherein the converter module includes a first dynamic seal and a second dynamic seal on the piston, and a seal chamber between the first and second dynamic seals is fluidically connectable to one of a hydraulic control line and annulus pressure.

Embodiment 6: The borehole system as in any prior embodiment, wherein the converter module includes a housing having a first section and a second section, the housing having the balance line chamber and the seal chamber and supporting the piston within the first section to form the seal chamber, wherein a leak path connecting the balance line chamber and seal chamber is formed when the second dynamic seal enters the second section.

Embodiment 7: The borehole system as in any prior embodiment, further comprising a first chamber within the housing and a spring within the first chamber, wherein the spring acts against the piston towards the balance line chamber, wherein the first chamber has a lower pressure than a pressure of a hydraulic control line of the downhole tool.

Embodiment 8: The borehole system as in any prior embodiment, further comprising the downhole tool, and a hydraulic control line fluidically connected to the downhole tool to provide hydraulic control pressure on a first end of a piston in the downhole tool, the converter module pressure acting on a second end of the piston in the downhole tool.

Embodiment 9: The borehole system as in any prior embodiment, wherein the downhole tool is a safety valve having a flapper, wherein the safety valve is configured to receive hydraulic pressure through the hydraulic control line to open the flapper, compress a power spring within the safety valve, and force balance fluid into the balance line chamber to push upon the piston in the converter module.

Embodiment 10: The borehole system as in any prior embodiment, wherein the hydraulic control line is fluidically connected to a seal chamber in the converter module between two dynamic seals on the piston within the converter module.

Embodiment 11: The borehole system as in any prior embodiment, wherein the converter module includes a spring acted upon by the piston in the converter module upon receipt of balance line fluid in the balance line chamber.

Embodiment 12: The borehole system as in any prior embodiment, wherein the converter module includes a housing having a first port and a second port, and further having a first chamber, a second chamber, and a third chamber, the piston disposed within the housing, the piston having a first end and a second end, the first chamber adjacent the first end of the piston, and the second chamber adjacent the second end of the piston, a first dynamic seal capable of sealing the piston within at least a portion of the housing and a second dynamic seal capable of sealing the piston within at least a portion of the housing, the third chamber disposed between the first and second dynamic seals, wherein the first port is fluidically accessible to the third chamber and is fluidically connectable to a source of pressure, and the second port is fluidically accessible to the second chamber and is fluidically connectable to the downhole tool.

Embodiment 13: The borehole system as in any prior embodiment, wherein the housing includes a first section and a second section, the second dynamic seal seals the piston to the housing when the second dynamic seal is in the first section of the housing, and the second chamber and the third chamber are fluidically connected when the second dynamic seal is positioned in the second section of the housing.

Embodiment 14: A method of connecting a downhole tool to a source of balance pressure, the method including fluidically connecting a balance line chamber of a converter module to a balance line of the downhole tool, the converter module having a piston, the piston fluidically engageable with the balance line chamber, wherein the piston is movable in response to changes in balance line fluid pressure within the balance line chamber.

Embodiment 15: The method of as in any prior embodiment further comprising connecting both the converter module and the downhole tool within a string of a borehole system.

Embodiment 16: A converter module configured to connect a downhole tool to a source of balance pressure, the converter module including a housing having a first port and a second port, and further having a first chamber, a second chamber, and a third chamber, a piston disposed within the housing, the piston having a first end and a second end, the first chamber adjacent the first end of the piston, and the second chamber adjacent the second end of the piston, a first dynamic seal capable of sealing the piston within at least a portion of the housing and a second dynamic seal capable of sealing the piston within at least a portion of the housing, the third chamber disposed between the first and second dynamic seals, wherein the first port is fluidically accessible to the third chamber and is fluidically connectable to a source of pressure, and the second port is fluidically accessible to the second chamber and is fluidically connectable to the downhole tool.

Embodiment 17: The converter module as in any prior embodiment, further comprising a source of potential energy arranged to bias the piston towards the second chamber.

Embodiment 18: The converter module as in any prior embodiment, wherein the housing includes a first section and a second section, the second dynamic seal seals the piston to the housing when the second dynamic seal is in the first section of the housing, and the second chamber and the third chamber are fluidically connected when the second dynamic seal is positioned in the second section of the housing.

Embodiment 19: A method of changing a source of balance line pressure in a balance line type downhole tool, the method including fluidically connecting the second chamber of the converter module as in any prior embodiment to a balance line of the downhole tool.

Embodiment 20: The method as in any prior embodiment, further comprising connecting both the converter module and the downhole tool within a string of a borehole system.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” can include a range of +8% of a given value.

The teachings of the present disclosure may be used in a variety of well operations. These operations may involve using one or more treatment agents to treat a formation, the fluids resident in a formation, a borehole, and/or equipment in the borehole, such as production tubing. The treatment agents may be in the form of liquids, gases, solids, semi-solids, and mixtures thereof. Illustrative treatment agents include, but are not limited to, fracturing fluids, acids, steam, water, brine, anti-corrosion agents, cement, permeability modifiers, drilling muds, emulsifiers, demulsifiers, tracers, flow improvers etc. Illustrative well operations include, but are not limited to, hydraulic fracturing, stimulation, tracer injection, cleaning, acidizing, steam injection, water flooding, cementing, etc.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A borehole system having a string, the string comprising:
a converter module fluidically connectable to a downhole tool, the converter module including a piston in fluidic communication with the downhole tool;
wherein the converter module is configured to provide a source of converter module pressure to the downhole tool.

2. The borehole system of claim 1, wherein the downhole tool is configured to receive hydraulic control pressure from a surface location by a hydraulic control line, and the converter module is configured to replace hydrostatic pressure from the hydraulic control line.

3. The borehole system of claim 1, wherein the converter module includes a stored energy source on one end of the piston and a balance line chamber in fluidic communication with the opposite end of the piston, the stored energy source configured to push the piston further into the balance line chamber upon a decrease of pressure within the balance line chamber.

4. The borehole system of claim 3, wherein the stored energy source includes at least one of a spring and a nitrogen charge.

5. The borehole system of claim 3, wherein the converter module includes a first dynamic seal and a second dynamic seal on the piston, and a seal chamber between the first and second dynamic seals is fluidically connectable to one of a hydraulic control line and annulus pressure.

6. The borehole system of claim 5, wherein the converter module includes a housing having a first section and a second section, the housing having the balance line chamber and the seal chamber and supporting the piston within the first section to form the seal chamber, wherein a leak path connecting the balance line chamber and seal chamber is formed when the second dynamic seal enters the second section.

7. The borehole system of claim 3, further comprising a first chamber within the housing and a spring within the first chamber, wherein the spring acts against the piston towards the balance line chamber, wherein the first chamber has a lower pressure than a pressure of a hydraulic control line of the downhole tool.

8. The borehole system of claim 3, further comprising the downhole tool, and a hydraulic control line fluidically connected to the downhole tool to provide hydraulic control pressure on a first end of a piston in the downhole tool, the converter module pressure acting on a second end of the piston in the downhole tool.

9. The borehole system of claim 8, wherein the downhole tool is a safety valve having a flapper, wherein the safety valve is configured to receive hydraulic pressure through the hydraulic control line to open the flapper, compress a power spring within the safety valve, and force balance fluid into the balance line chamber to push upon the piston in the converter module.

10. The borehole system of claim 8, wherein the hydraulic control line is fluidically connected to a seal chamber in the converter module between two dynamic seals on the piston within the converter module.

11. The borehole system of claim 8, wherein the converter module includes a spring acted upon by the piston in the converter module upon receipt of balance line fluid in the balance line chamber.

12. The borehole system of claim 1, wherein the converter module comprises:
a housing having a first port and a second port, and further having a first chamber, a second chamber, and a third chamber;
the piston disposed within the housing, the piston having a first end and a second end, the first chamber adjacent the first end of the piston, and the second chamber adjacent the second end of the piston;
a first dynamic seal capable of sealing the piston within at least a portion of the housing and a second dynamic seal capable of sealing the piston within at least a portion of the housing, the third chamber disposed between the first and second dynamic seals;
wherein the first port is fluidically accessible to the third chamber and is fluidically connectable to a source of pressure, and the second port is fluidically accessible to the second chamber and is fluidically connectable to the downhole tool.

13. The borehole system of claim 12, wherein the housing includes a first section and a second section, the second dynamic seal seals the piston to the housing when the second dynamic seal is in the first section of the housing, and the second chamber and the third chamber are fluidically connected when the second dynamic seal is positioned in the second section of the housing.

14. A method of connecting a downhole tool to a source of balance pressure, the method comprising:
fluidically connecting a balance line chamber of a converter module to a balance line of the downhole tool, the converter module having a piston, the piston fluidically engageable with the balance line chamber;
wherein the piston is movable in response to changes in balance line fluid pressure within the balance line chamber.

15. The method of claim 14 further comprising connecting both the converter module and the downhole tool within a string of a borehole system.

16. A converter module configured to connect a downhole tool to a source of balance pressure, the converter module comprising:
a housing having a first port and a second port, and further having a first chamber, a second chamber, and a third chamber;
a piston disposed within the housing, the piston having a first end and a second end, the first chamber adjacent the first end of the piston, and the second chamber adjacent the second end of the piston;
a first dynamic seal capable of sealing the piston within at least a portion of the housing and a second dynamic seal capable of sealing the piston within at least a portion of the housing, the third chamber disposed between the first and second dynamic seals;
wherein the first port is fluidically accessible to the third chamber and is fluidically connectable to a source of pressure, and the second port is fluidically accessible to the second chamber and is fluidically connectable to the downhole tool.

17. The converter module of claim 16, further comprising a source of potential energy arranged to bias the piston towards the second chamber.

18. The converter module of claim 17, wherein the housing includes a first section and a second section, the second dynamic seal seals the piston to the housing when the second dynamic seal is in the first section of the housing, and the second chamber and the third chamber are fluidically connected when the second dynamic seal is positioned in the second section of the housing.

19. A method of changing a source of balance line pressure in a balance line type downhole tool, the method comprising:
fluidically connecting the second chamber of the converter module of claim 16 to a balance line of the downhole tool.

20. The method of claim 19, further comprising connecting both the converter module and the downhole tool within a string of a borehole system.
